(19) United States
(12) Patent Application Publication
(10) Pub. No.: US 2002/0119215 A1
(43) Pub. Date: Aug. 29, 2002

(54) Injection molding device

(75) Inventors: Roderich Ettlinger, Konigsbrunn (DE); Eduard Johan Gerard Klobbie, Sneek (NL)

Correspondence Address: BLANK ROME COMISKY & MCCAULEY LLP, THE FARRAGUT BUILDING SUITE 1000, 900 17TH STREET NW, WASHINGTON, DC, 20006, US

(73) Assignee: WAVIN LASH V.O.F., AD Sneek (NL)

(21) Appl. No.: 10/094,130

(22) Filed: Mar. 11, 2002

Related U.S. Application Data
(63) Continuation of application No. PCT/NL00/00645, filed on Sep. 12, 2000.

(30) Foreign Application Priority Data
Sep. 17, 1999 (NL) 1013078

(51) Int. Cl. B29C 45/66

(52) U.S. Cl. 425/589; 425/450.1

(57) ABSTRACT

The invention relates to a device for injection molding a plastic object. The device comprises a frame with a first platen and a second platen, which are respectively designed for fixing thereto a first mould half and a second mould half of an injection mould.

One or both platens has/have displacement means which enable the platens to be displaced towards one another from an open position and to be moved into a closed position. Furthermore, there are means for creating a closure force, by means of which the mould halves can be pressed together in the closed position of the platens, and means for injecting plastics material into the mould under pressure.

The means for creating the closure force comprise one or more closure clamps which can each be displaced substantially transversely with respect to the closure direction of the platens.

### CROSS-REFERENCE TO RELATED APPLICATION

This is a continuation application of PCT/NL00/00645 filed Sep. 12, 2000, which PCT application claims priority of Dutch patent application number 1013078 filed Sep. 17, 1999, herein incorporated by reference.

### FIELD OF THE INVENTION

The present invention relates to a device for injection moulding a plastic object, comprising a frame, a first platen and a second platen, which are respectively designed for fixing thereto a first mould half and a second mould half of an injection mould. The device further comprises a displacement means belonging to at least one of said first and second platens, enabling said first and said second platens to be displaced towards one another in a closure direction from an open position into a closed position, in which said first mould half and said second mould half bear against one another. The device is provided with closure force means for creating a closure force, by means of which said first mould half and said second mould half, in the closed position of said first and said second platens, can be held pressed together at least while plastics material is being injected into said mould, the closure force means comprising one or more closure clamps which are each displaceable substantially transversely with respect to said closure direction. The device further comprises injecting means for injecting plastics material into said mould.

### BACKGROUND OF THE INVENTION

Injection moulding devices of this nature are generally known. In many known injection moulding devices, one platen is held in a stationary position in the frame which is on the ground, and the other platen is displaceable. For this purpose, a toggle joint mechanism is often provided, which in addition to the displacement of the platen also creates the closure force. This mechanism is usually arranged between the movable platen and a support plate which is attached to the stationary platen by a plurality of tie rods.

The closure force is required in order to hold the two mould halves sealed together while the plastics material, which has been injected under high pressure into the mould, is seeking to press these halves apart. Particularly in the case of large plastic products, such as table tops and transport pallets, the considerable surface area of these products means that a very high closure force is required. To produce pallets, which are manufactured in standard dimensions of 800×1200 mm, 1000×1200 mm or even 1400×1400 mm, closure forces of around 30,000 kN are required. A very high closure force of this nature has to be distributed uniformly over the contact surface between the mould halves, also known as the closure face or parting face. If the closure force is distributed unevenly, there is a risk of the injected plastics material leaking out, and also of deformation to the expensive mould.

In some moulds, such as in moulds for transport pallets, one or more cores which are each inserted from the outside into an associated insertion opening in the injection mould are also involved. Particularly if an insertion opening of this nature is situated at the parting plane of the mould halves, i.e. in such a manner that the core is, as it were, enclosed or clamped between the two mould halves, and therefore there are sealing surfaces between this core and the mould halves, the abovementioned problem of deformation plays an important role. This is because local deformation of the mould halves may also damage the core, and consequently, the core will no longer function correctly.

The abovementioned problems of deformation to the mould and leakage play a role in particular with moulds made from aluminium, but also occur with other materials.

EP 0 420 098 describes an injection moulding device, in which an additional closure force is obtained along the outer circumference of the mould by means of closure clamps with wedge-shaped means which press the edges of the two mould halves together. The closure clamps engage on projections which are formed on the two mould halves. These projections, which have to be able to withstand considerable loads, therefore have to be made on each mould half, and consequently the moulds are even more expensive. Moreover, the mould halves may be deformed as a result of these closure clamps not distributing their closure force uniformly over the entire area of the closure face of the mould halves. The position of the closure clamp and the associated means for exerting pressure on the closure clamp limits the space available for cores belonging to the mould.

In practice, it has been found that the above problems occur to an undesirably frequent extent in the injection moulding devices which are known to date.

### SUMMARY OF THE INVENTION

The object of the invention is to provide an injection moulding device which solves these problems and, in particular, enables large products to be injection moulded, requiring enormous closure forces.

The invention provides a device wherein each closure clamp is designed to act, in an active position thereof, on said first and said second platens, which are in their closed position, a pressure means being provided for each closure clamp, for exerting a pressing force on said closure clamp—in said active position of said closure clamp—towards said first and second platens, each closure clamp and at least one of said first and said second platens being provided with wedge means which, in said active position of said closure clamp, interact in such a manner that, as a result of said closure clamp or closure clamps being pressed towards said first and second platens via the wedge means, the closure force of said mould is produced.

The invention is based on the insight that, with closure clamps of this nature which act on the robust platens, it is possible to produce very high closure forces, which may also be distributed well over the platens, for example may be distributed over a plurality of locations along two opposite sides of the platens. Furthermore, it is technically eminently possible for the platens themselves to be of very robust design and to be provided with wedge means. Consequently, the moulds which are to be placed into the device do not have to be specially adapted.

High closure forces can be produced in particular if the wedge means have a wedge angle, said wedge angle being such that said closure force is considerably greater than said pressing force exerted by said pressure means. As is known per se, a wedge structure enables the force exerted to be increased considerably.

The measure according to the invention allows the displacement means for displacing the platens towards and away from one another to be of relatively lightweight design, and, in particular, means that the displacement means in question does not have to make any contribution, or at least any significant contribution, to the closure force which is to be applied and which is then produced entirely by means of the closure clamps. To successfully control the closure force and distribute it across the mould, it is possible for each closure clamp to be provided with a separately actuable pressure means, preferably a hydraulic actuator, for exerting a pressing force on the closure clamp, so that the pressing force exerted on each closure clamp is separately adjustable. Herewith the closure force exerted by this clamp can be accurately adjusted.

When using a mould with a core which is enclosed between the two mould halves and is situated on a side of the mould where a closure clamp is situated, it is preferable for the core to be attached to the closure clamp and to move with this closure clamp. The core then moves into its associated insertion opening in the mould when the closure clamp is moved into the active position. Furthermore, there is preferably a core pressure means for exerting pressure on this mould core, which means is arranged between the closure clamp and the mould core and enables the force to be exerted on this core to be adjusted and regulated independently of the closure force generated by the closure clamps.

It is preferable for the closure force required to be generated first, and for the required force on the core then to be adjusted with the aid of the means for exerting pressure on the core. The means for exerting pressure on the core is preferably a hydraulic actuator.

Further advantageous embodiments of the injection moulding device according to the invention are described in the claims and will be explained in more detail below with reference to the drawing.

### BRIEF DESCRIPTION OF THE DRAWINGS

FIG. 1 shows a diagrammatic, perspective view of an exemplary embodiment of an injection moulding device according to the invention, and

FIG. 2 diagrammatically depicts a plan view, partially in section, of part of the device shown in FIG. 1, with a mould positioned therein.

### DESCRIPTION OF THE PREFERRED EMBODIMENT

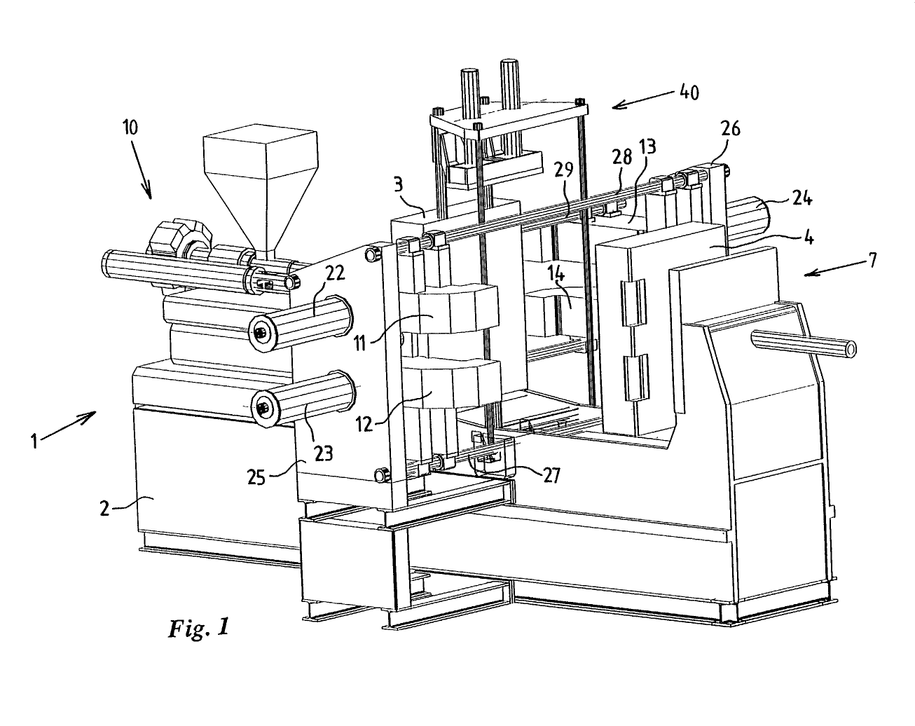

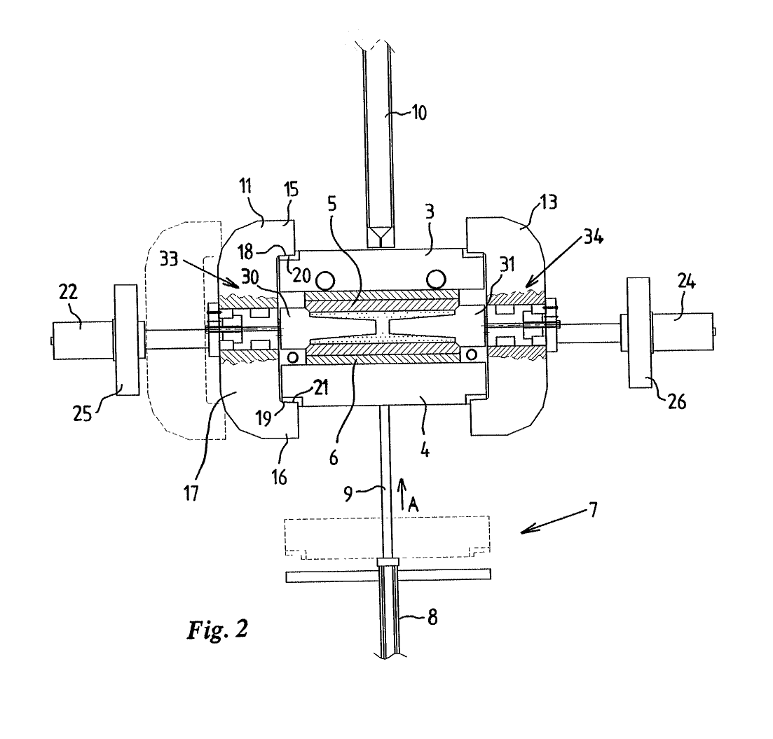

FIGS. 1 and 2 show an exemplary embodiment of a device 1 according to the invention for injection moulding a plastic object, in this example a transport pallet. To produce pallets of this nature, it is common in practice to use polypropylene or polyethylene (PP or PE), to which a small amount of foaming agent has been added in order to in this way ensure that the injected plastic compound completely fills the large mould cavity. The mould is not shown in FIG. 1 and is only indicated very diagrammatically in FIG. 2. It will be clear that the mould is very large.

The device 1 comprises a frame 2 which is positioned on the floor.

On the frame 2 there is a first platen 3 which is attached in a stationary position to the frame 2. Furthermore, there is a second platen 4 which can move with respect to the frame 2.

The first and second platens 3, 4 are highly robust components and each have a vertical mounting surface for a first mould half 5 and a second mould half 6 of an injection mould for the injection moulding of a pallet to be fixed to (cf. FIG. 2). Various methods for fixing the mould halves to the platens 3, 4, which will not be explained in any further detail, are known from the prior art.

Displacement means 7 belong to the movable platen 4, enabling the platen 4 to be displaced from an open position (cf. FIG. 1 and dashed lines in FIG. 2) in a closure direction (arrow A in FIG. 2) towards the stationary platen 3 and to be moved into a closed position (cf. FIG. 2), in which the first and second mould halves 5, 6 bear against one another.

In this example, the displacement means 7 comprise a linear hydraulic cylinder 8 which is attached to the frame 2 and has a piston rod 9 which is attached to the platen 4.

The device 1 furthermore comprises an extruder 10 which is suitable for injecting plastics material into the closed mould. Extruders 10 of this nature and associated means are generally known and will not be explained in further detail here.

To ensure that the mould halves 5, 6 remain pressed firmly against one another during the injection of the plastics material under pressure, an enormous closure force, with which the mould halves 5, 6 are pressed together in the closed position of the platens 3, 4, is required, in view of the large surface of a product such as a pallet.

To provide the closure force, it is not the cylinder 8 which is used, but rather two sets of in each case two closure clamps 11, 12, 13, 14 positioned above one another are provided in the device 1.

Each of the closure clamps 11, 14 has a robust, U-shaped metal body with two short limbs 15, 16 and a joining web 17 which extends substantially transversely with respect to the platens 3, 4 (cf. clamp 11 in FIG. 2).

Each closure clamp 11, 14 can be displaced transversely with respect to the closure direction of the platens, between an inactive position (cf. FIG. 1 and dashed lines for clamp 11 in FIG. 2), in which it is possible for the platens 5, 6 to be displaced using the associated displacement means 7, and an active position (cf. solid lines for clamps 11 and 13 in FIG. 2), in which the associated closure clamp engages on the two platens 3, 4 which are in their closed position. It can be seen clearly from FIG. 2 that an edge region of the platens 3, 4 is enclosed between the limbs 15, 16 of the closure clamp 11 in its active position.

On the side facing towards the platens, the two limbs 15, 16 of the clamp 11 and of the other clamps 12, 14 are provided with a wedge face 18, 19, which wedge faces 18, 19, in the active position of the closure clamp 11, each bear against an associated wedge face 20, 21 which is arranged along a vertical side edge of the platen 3, 4, respectively.

Each closure clamp 11, 14 has an associated means for exerting pressure on the closure clamp, which is respectively denoted by 22-24 in FIGS. 1 and 2, the means for closure clamp 14 not being visible, for—in the active position of the closure clamp 11-14—pressing the closure clamp 11, 14 towards the platens 3, 4. In the example shown, the means for exerting pressure on the closure clamp are designed as hydraulic cylinders. In a preferred embodiment, the pressure exerted by each cylinder for exerting pressure on the closure clamp can be adjusted separately, so that in this way it is possible to influence the distribution of the closure force over the parting plane of the mould.

The interacting wedge means which are arranged on the closure clamps and the platens and interact in the active position of the closure clamps are such that, as a result of the closure clamps being pressed towards the platens 3, 4 via the wedge means, the closure force with which the mould halves 3, 4 are pressed together is created.

By suitably selecting the effective wedge angle of the wedge means 18, 21, it is possible for the force supplied by the cylinders 22-24 for exerting pressure on the closure clamp to be magnified when it is converted into the closure force. This structure enables closure forces of 30,000 kN to be achieved.

It will be clear that the wedge faces 18, 21 are exposed to very considerable loads. For this reason, it is advantageous for the wedge faces 18, 21 to be formed by a wedge component, possibly made from a special material, which is removably fixed to the closure clamp and/or the platen.

The arrangement of the closure clamps 11, 14 ensures that the closure force exerted by the closure clamps is applied to the platens 3, 4 on two opposite vertical sides.

FIG. 1 shows that the closure-clamp cylinders 22, 23 are mounted in a robust support plate 25 and the other cylinders 24 for exerting pressure on the closure clamp are mounted in a support plate 26. The support plates 25, 26 are connected to one another by tie rods 27, 29.

To prevent the cylinders 22, 24 being subjected to the load from the weight of the heavy closure clamps 11, 14, there is provision for the closure clamps to be guided displaceably in an associated guide structure which is supported on the frame 2. In this example, the tie rods 27, 29 serve as the guide structure for the closure clamps 11-14.

FIG. 2 shows that the mould, as is known per se for moulds for transport pallets, is provided, on the sides facing towards the closure clamps 11, 14, with a core insertion opening, specifically two core insertion openings. These core insertion openings are used for the insertion of a mould core from the outside, the cores which are to be inserted into the mould from each side ultimately forming the slots in the pallet for the forks of a fork-lift truck. Two of these cores 30, 31 are diagrammatically indicated in FIG. 2. Ultimately, therefore, the two mould halves 3, 4 and all the cores which have been fitted into them delimit the mould cavity, which corresponds to the shape of the product to be injection moulded.

It can be seen from FIG. 2 that the core insertion openings for the cores 30, 31 are situated at the parting plane of the first and second mould halves 5, 6, so that the cores 30, 31 are enclosed between these two halves 5, 6.

It will be clear that there must be no seams between the cores 30, 31 and the mould halves 5, 6, along which plastic could escape from the mould, and consequently sealing surfaces are present, by means of which the cores and the mould halves 5, 6 have to be pressed together in a sealed manner.

A separate means 33, 34 for exerting pressure is provided for each core 30, 31, which means is designed to press the core, which has been inserted into the mould, with a certain force into the mould. The means 33, 34 for exerting pressure on the core are respectively arranged on the closure clamps 11 and 13, so that each means for exerting pressure on the core moves with the associated closure clamp. The cores 30, 31 are removably attached to the associated means for exerting pressure on the core.

The means 33, 34 for exerting pressure on the core are in this case designed as hydraulic cylinders with a short stroke. The pressure exerted by each means 33, 34 for exerting pressure on the core can be adjusted separately.

The means 33, 34 for exerting pressure on the core enable the force with which the cores are pressed into the mould to be adjusted independently of the closure force for the mould. Furthermore, the insertion depth of the cores is consequently independent of the position of the closure clamps. These two measures allow extremely reliable sealing between the cores, on the one hand, and the mould halves 5, 6, on the other hand, irrespective of any wear to the cores or the mould halves or any thermal deformations.

In a preferred embodiment, it is possible for the pressure to which the cores are exposed to be adapted during the injection moulding.

FIG. 1 also shows a mechanism 40 enabling one or more cores to be introduced into the mould on the top-side as well, which mechanism 40 will not be explained in more detail here. It is also possible for cores of this nature to be introduced into the mould from below, using a mechanism which is not shown in the drawing.

What is claimed is:

1. A device for injection moulding a plastic object, comprising:
a frame,
a first platen and a second platen, which are respectively designed for fixing thereto a first mould half and a second mould half of an injection mould,
displacement means belonging to at least one of said first and second platens, enabling said first and said second platens to be displaced towards one another in a closure direction from an open position into a closed position, in which said first mould half and said second mould half bear against one another,
closure force means for creating a closure force, by means of which said first mould half and said second mould half, in the closed position of said first and said second platens, can be held pressed together at least while plastics material is being injected into said mould, the closure force means comprising one or more closure clamps which are each displaceable substantially transversely with respect to said closure direction, and
injecting means for injecting plastics material into said mould, wherein each closure clamp is designed to act, in an active position thereof, on said first and said second platens, which are in their closed position, a pressure means being provided for each closure clamp, for exerting a pressing force on said closure clamp—in said active position of said closure clamp—towards said first and second platens, each closure clamp and at least one of said first and said second platens being provided with wedge means which, in said active position of said closure clamp, interact in such a manner that, as a result of said closure clamp or closure clamps being pressed towards said first and second platens via the wedge means, the closure force of said mould is produced.

2. A device according to claim 1, in which the wedge means have a wedge angle, said wedge angle being such that said closure force is considerably greater than said pressing force exerted by said pressure means.

3. A device according to claim 2, in which said wedge means comprise a wedge face arranged on said closure clamp, and a wedge face arranged on at least one of said first and said second platens, which wedge faces bear against one another in said active position of said closure clamp.

4. A device according to claim 3, in which the wedge face arranged on at least one of said first and said second platens is formed by a wedge component which is removabely attached to said platen.

5. A device according to claim 3, in which said closure clamp is U-shaped, having two limbs and a joining web, said joining web extending substantially transversely with respect to said first and said second platens, and said wedge face being provided on one or both limbs of said closure clamp, said wedge face being able to interact with said wedge face arranged on said associated first and/or second platens.

6. A device according to claim 1, in which one or more closure clamps are provided on opposite sides of said first and said second platens, by means of which closure clamps a closure force can be exerted on said opposite sides of said first and said second platens.

7. A device according to claim 1, in which each closure clamp has a separately actuable pressure means for exerting a pressing force on the closure clamp, so that the pressing force exerted on each closure clamp is separately adjustable.

8. A device according to claim 1, in which said pressure means is a hydraulic actuator.

9. A device according to claim 1, in which each pressure means is supported on an associated support structure.

10. A device according to claim 1, in which one or more closure clamps are provided on opposite sides of said first and said second platens, by means of which closure clamps a closure force can be exerted on said opposite sides of said first and said second platens, in which each pressure means for exerting pressure on said closure clamp is supported on an associated support structure, the support structures of opposite closure clamps being connected to one another by one or more tie rods.

11. A device according to claim 1, in which one or more closure clamps are provided on opposite sides of said first and said second platens, by means of which closure clamps a closure force can be exerted on said opposite sides of said first and said second platens, in which each pressure means for exerting pressure on said closure clamp is supported on an associated support, the support structures of opposite closure clamps being connected to one another by one or more tie rods, the closure clamps being guided displaceably over said one or more tie rods.

12. A device according to claim 1, in which said first mould half and said second mould half bear against one another on a parting plane and said mould has an insertion opening for inserting a mould core from outside, said insertion opening being situated at said parting plane, and said insertion opening being situated on a side of said mould which faces towards a closure clamp, said mould core being attached to said closure clamp, so that said mould core moves with said closure clamp.

13. A device according to claim 1, in which said first mould half and said second mould half bear against one another on a parting plane and said mould has an insertion opening for inserting a mould core from outside, said insertion opening being situated at said parting plane, and said insertion opening being situated on a side of said mould which faces towards a closure clamp, said mould core being attached to said closure clamp, so that said mould core moves with said closure clamp, whereby a core pressure means for exerting pressure on said mould core is provided, said core pressure means being arranged between said closure clamp and said mould core and being designed to press said mould core, which has been inserted into said mould, with a certain force into said mould.

14. A device according to claim 1, in which said first mould half and said second mould half bear against one another on a parting plane and said mould has an insertion opening for inserting a mould core from outside, said insertion opening being situated at said parting plane, and said insertion opening being situated on a side of said mould which faces towards a closure clamp, said mould core being attached to said closure clamp, so that said mould core moves with said closure clamp, whereby a core pressure means for exerting pressure on said mould core is provided, said core pressure means being arranged between said closure clamp and said mould core and being designed to press said mould core, which has been inserted into said mould, with a certain force into said mould, said core pressure means being separately actuable.

15. A device according to claim 1, in which said first mould half and said second mould half bear against one another on a parting plane and said mould has an insertion opening for inserting a mould core from outside, said insertion opening being situated at said parting plane, and said insertion opening being situated on a side of said mould which faces towards a closure clamp, said mould core being attached to said closure clamp, so that said mould core moves with said closure clamp, whereby a core pressure means for exerting pressure on said mould core is provided, said core pressure means being arranged between said closure clamp and said mould core and being designed to press said mould core, which has been inserted into said mould, with a certain force into said mould, said mould core being removably attached to said core pressure means.

16. A device according to claim 1, in which said first mould half and said second mould half bear against one another on a parting plane and said mould has an insertion opening for inserting a mould core from outside, said insertion opening being situated at said parting plane, and said insertion opening being situated on a side of said mould which faces towards a closure clamp, said mould core being attached to said closure clamp, so that said mould core moves with said closure clamp, whereby a core pressure means for exerting pressure on said mould core is provided, said core pressure means being arranged between said closure clamp and said mould core and being designed to press said mould core, which has been inserted into said mould, with a certain force into said mould, said core pressure means being a hydraulic actuator.

17. A device according to claim 1, in which said first mould half and said second mould half bear against one another on a parting plane and said mould has an insertion opening for inserting a mould core from outside, said insertion opening being situated at said parting plane, and said insertion opening being situated on a side of said mould which faces towards a closure clamp, said mould core being attached to said closure clamp, so that said mould core moves with said closure clamp, whereby a core pressure means for exerting pressure on said mould core is provided, said core pressure means being arranged between said closure clamp and said mould core and being designed to press said mould core, which has been inserted into said mould, with a certain force into said mould, whereby said core pressure means enables the pressure exerted on said mould core to be adjusted independently of the pressure exerted on said closure clamp.

18. A device for injection moulding a plastic object, comprising:
a frame,
a first platen and a second platen, which are respectively designed for fixing thereto a first mould half and a second mould half of an injection mould,
displacement means belonging to at least one of said first and said second platens, enabling said first and said second platens to be displaced towards one another in a closure direction from an open position into a closed position, in which said first mould half and said second mould half bear against one another on a parting plane,
said mould having an insertion opening for inserting a mould core from the outside, said insertion opening being situated at said parting plane,
closure force means for creating a closure force, by means of which said first mould half and said second mould half, in the closed position of said first and said second platens, can be held pressed together at least while plastics material is being injected into said mould, and
injecting means for injecting plastics material into said mould, wherein said device comprises a core pressure means for exerting pressure on said mould core, said core pressure means being designed to press said mould core, which has been inserted into said mould, with a certain force into said mould, and wherein said core pressure means for exerting pressure on said mould core can be actuated separately, enabling said pressure on said mould core to be adjusted independently of said closure force.

19. A device for injection moulding a plastic pallet, comprising:
a frame,
a first platen and a second platen, which are respectively designed for fixing thereto a first mould half and a second mould half of an injection mould for injection moulding a pallet,
displacement means belonging to at least one of said first and said second platens, enabling said first and said second platens to be displaced towards one another in a closure direction from an open position into a closed position, in which said first mould half and said second mould half bear against one another on a parting plane,
said mould having an insertion opening for inserting a mould core from the outside, said insertion opening being situated at said parting plane,
closure force means for creating a closure force, by means of which said first mould half and said second mould half, in said closed position of said first and said second platens, can be held pressed together at least while plastics material is being injected into said mould, and
injecting means for injecting plastics material into said mould, wherein said device comprises a core pressure means for exerting pressure on said mould core, said core pressure means being designed to press said mould core, which has been inserted into said mould, with a certain force into said mould, and wherein said core pressure means can be actuated separately, enabling said pressure on said mould core to be adjusted independently of said closure force.
